(19) United States
(12) Patent Application Publication
(10) Pub. No.: US 2023/0126508 A1
(43) Pub. Date: Apr. 27, 2023

(54) RELEASE LINER-ATTACHED ADHESIVE BODY

(71) Applicant: NITTO DENKO CORPORATION, Ibaraki-shi, Osaka (JP)

(72) Inventors: Atsushi TAKASHIMA, Ibaraki-shi, Osaka (JP); Hiromitsu MORISHITA, Ibaraki-shi, Osaka (JP)

(21) Appl. No.: 17/915,463

(22) PCT Filed: Mar. 26, 2021
(86) PCT No.: PCT/JP2021/013139

§ 371 Date: Sep. 28, 2022

(30) Foreign Application Priority Data
Mar. 31, 2020 (JP) 2020-064046

(51) Int. Cl. C09J 7/40

(52) U.S. Cl. CPC C09J 7/403; C09J 2301/202

(57) ABSTRACT

The present invention relates to a release liner-attached adhesive body including a linear adhesive body and a release liner, in which the release liner has a compression elastic modulus of 1.5 MPa or less, and a release liner-attached adhesive body including a linear adhesive body and a release liner, in which a slit is formed in the release liner, and at least a part of the adhesive body is disposed in the slit.

### TECHNICAL FIELD

The present invention relates to a release liner-attached adhesive body.

### BACKGROUND ART

A linear adhesive body is known in the related art. For example, Patent Literature 1 discloses a threadlike adhesive tool in which an adhesive is attached to a threadlike core material.

### CITATION LIST

### Patent Literature

Patent Literature 1: JP-A-H03-231980

### SUMMARY OF INVENTION

### Technical Problem

Such an adhesive body is linear, and thus can be easily applied to a narrow place or the like. In addition, unlike a liquid adhesive, there is no risk of dripping or squeezing out.

Here, in a general adhesive body, measures for protecting adhesive surfaces are taken during storage in order to prevent the adhesive surfaces from sticking to each other or to prevent dust and the like from adhering to the adhesive surfaces to reduce the adhesive force. For example, in a general single-sided adhesive tape, the adhesive surface is protected by winding such that the adhesive surface and the non-adhesive surface (back surface) are stuck to each other, or by sticking a release liner to the adhesive surface. In a double-sided adhesive tape, the adhesive surfaces are protected by sandwiching a release liner between the adhesive surfaces and winding the same such that the adhesive surfaces do not come into contact with each other, or by sticking a release liner to both the adhesive surfaces.

However, in the case of a linear adhesive body, a method for protecting the adhesive surface during storage has not been sufficiently studied.

Patent Literature 1 describes a method of disposing, without using a release liner, a threadlike adhesive tool in a reel by winding the threadlike adhesive tool around the reel such that parts in close contact with each other are reduced. However, such a form can be applied only to an adhesive body having a small adhesive force since it is difficult to peel off the adhesive bodies from each other when the adhesive force of the threadlike adhesive tool is large.

In protecting the adhesive surface of the linear adhesive body, it is conceivable to protect the adhesive surface by using a release liner as in the case of the double-sided adhesive tape. That is, it is conceivable to protect the adhesive body by a method of clamping the linear adhesive body using a release liner as used in the adhesive tape, and winding and sandwiching a release liner between linear adhesive bodies. Such a method can also be applied to an adhesive body with a large adhesive force.

However, in such a method, the adhesive body may be crushed by the pressure due to clamping or tightening during winding, and the form of the adhesive body may be damaged. In addition, since the adhesive body is linear while the release liner is flat, the adhesive body may roll on the release liner and fall off from the release liner.

The present invention has been made in view of the above, and an object thereof is to provide a release liner-attached adhesive body that suppresses or prevents crushing and falling of a linear adhesive body.

### Solution to Problem

An aspect of the present invention relates to a release liner-attached adhesive body including a linear adhesive body and a release liner, in which the release liner has a compression elastic modulus of 1.5 MPa or less.

In the above release liner-attached adhesive body, a slit may be formed in the release liner, and at least a part of the adhesive body may be disposed in the slit.

In addition, another aspect of the present invention relates to a release liner-attached adhesive body including a linear adhesive body and a release liner, in which a slit is formed in the release liner, and at least a part of the adhesive body is disposed in the slit.

In the release liner-attached adhesive body according to the above aspects, the slit may be formed along a longitudinal direction of the release liner.

In the release liner-attached adhesive body according to the above aspects, the adhesive body is preferably threadlike.

In the release liner-attached adhesive body according to the above aspects, the release liner-attached adhesive body may be wound in a roll shape.

### Advantageous Effects of Invention

The release liner-attached adhesive body according to the present invention can suppress or prevent crushing and falling of the linear adhesive body.

### BRIEF DESCRIPTION OF DRAWINGS

FIG. 1A is a schematic diagram showing a state where a release liner-attached adhesive body according to one configuration example of a first embodiment of the present invention is wound in a roll shape (a roll-shaped release liner-attached adhesive body), and

FIG. 1B is a cross-sectional view showing a cross section of the roll-shaped release liner-attached adhesive body according to the configuration example, which is perpendicular to a winding direction.

FIG. 2 is a perspective view showing a state where the release liner-attached adhesive body according to the configuration example of the first embodiment of the present invention is wound on a reel.

FIG. 3A and FIG. 3B show diagrams showing a specific example of a method of winding a release liner-attached and threadlike adhesive.

FIG. 4 is a diagram showing another specific example of the method of winding the release liner-attached and threadlike adhesive.

FIG. 5A is a cross-sectional view showing a cross section of a release liner perpendicular to a longitudinal direction thereof according to one configuration example of a second embodiment of the present invention, and FIG. 5B is a cross-sectional view showing a cross section of a roll-shaped release liner-attached adhesive body according to the configuration example, which is perpendicular to a winding direction.

FIG. 6A is a cross-sectional view showing a cross section of the release liner-attached adhesive body perpendicular to a longitudinal direction thereof according to the configuration example of the second embodiment of the present invention, and FIG. 6B is a cross-sectional view showing a cross section of the roll-shaped release liner-attached adhesive body according to the configuration example, which is perpendicular to the winding direction.

FIG. 7A is a cross-sectional view showing a cross section of the release liner-attached adhesive body perpendicular to the longitudinal direction thereof according to the configuration example of the second embodiment of the present invention, and FIG. 7B is a cross-sectional view showing a cross section of the roll-shaped release liner-attached adhesive body according to the configuration example, which is perpendicular to the winding direction.

### DESCRIPTION OF EMBODIMENTS

A release liner-attached adhesive body according to a first embodiment of the present invention includes a linear adhesive body and a release liner, in which the release liner has a compression elastic modulus of 1.5 MPa or less.

A release liner-attached adhesive body according to a second embodiment of the present invention includes a linear adhesive body and a release liner, in which a slit is formed in the release liner, and at least a part of the adhesive body is disposed in the slit.

Hereinafter, these embodiments will be described in detail. The present invention is not limited to the embodiments to be described below. In the following drawings, members and parts having the same functions may be described with the same reference numerals, and duplicate descriptions may be omitted or simplified. The embodiments described in the drawings are schematically for the purpose of clearly illustrating the present invention, and do not necessarily accurately represent a size or scale of an actual product.

In the present description, the term “linear” is a concept that includes not only a straight line, a curved line, a polygonal line, etc., but also a state where a material can be bent in various directions and angles like a thread (hereinafter, also referred to as “threadlike”).

### First Embodiment

A release liner-attached adhesive body according to a first embodiment of the present invention includes a linear adhesive body and a release liner, in which the release liner has a compression elastic modulus of 1.5 MPa or less. The compression elastic modulus of the release liner in the present embodiment is preferably 1.2 MPa or less, and more preferably 1 MPa or less. The lower limit of the compression elastic modulus of the release liner in the present embodiment is not particularly limited, and is, for example, 0.001 MPa or more from the viewpoint of obtaining appropriate strength.

The compression elastic modulus can be measured by the method shown below.

The compression elastic modulus of the release liner can be measured by the following compression test using, for example, an autograph (small desktop tester EXtest manufactured by Shimadzu Corporation).

A release liner (length 4 cm×width 4 cm) is placed on an acrylic table in a room with a temperature of 23° C., the compression stress is measured while pressing a cylindrical indenter (made of SUS, indenter area: 100 mm²) in a direction perpendicular to the center of the release liner at a compression rate of 0.1 mm/min, and the compression elastic modulus E (MPa) is calculated according to the following equation.

E (MPa)=(σ2−σ1)/(ε2−ε1)

Compression stress σ1: 0.005 (MPa)

Compression stress σ2: 0.01 (MPa)

Compression strain value ε1: compression strain value under compression stress σ1

Compression strain value ε2: compression strain value under compression stress σ2

The release liner in the present embodiment has a compression elastic modulus of 1.5 MPa or less and is thus excellent in cushioning property. Accordingly, in the release liner-attached adhesive body according to the present embodiment, the linear adhesive body is stably protected in a state where crushing and falling are suppressed or prevented. The detailed description is as follows.

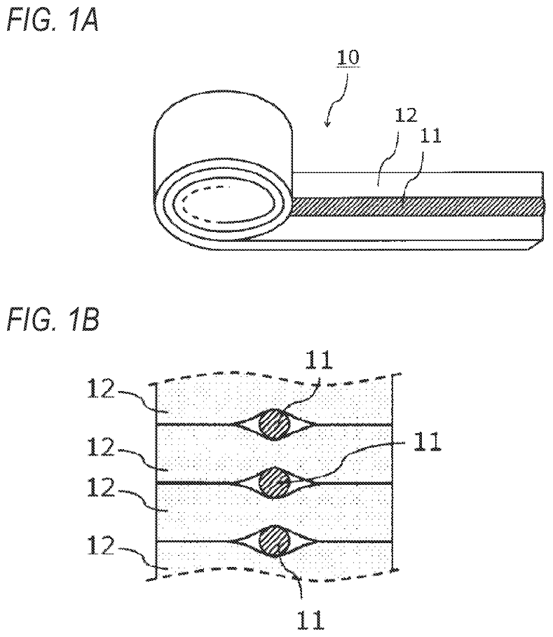

FIG. 1A is a schematic diagram showing a state where a release liner-attached adhesive body according to one configuration example of the present embodiment is wound in a roll shape (a roll-shaped release liner-attached adhesive body). In addition, FIG. 1B is a cross-sectional view showing a cross section of the roll-shaped release liner-attached adhesive body according to the configuration example, which is perpendicular to a winding direction. A release liner 12 in the present configuration example has a compression elastic modulus of 1.5 MPa or less and is excellent in cushioning property. Therefore, when wound together with a linear adhesive body 11, the release liner 12 is deformed according to the shape of the linear adhesive body 11 as shown in FIG. 1B. Accordingly, the stress received by the linear adhesive body 11 from the release liner 12 is alleviated, so that the crushing of the linear adhesive body 11 is suppressed or prevented, and the form as the adhesive body is retained. As shown in FIG. 1B, in a release liner-attached adhesive body 10 according to the present configuration example, since the linear adhesive body 11 is sandwiched by the release liner 12 so as to be wrapped around the release liner 12, the linear adhesive body is difficult to roll and is difficult to fall off from the release liner 12. In the example shown in FIG. 1B, there are some voids between the linear adhesive body 11 and the release liner 12, but the present embodiment is not limited to this. There may be no void between the linear adhesive body 11 and the release liner 12.

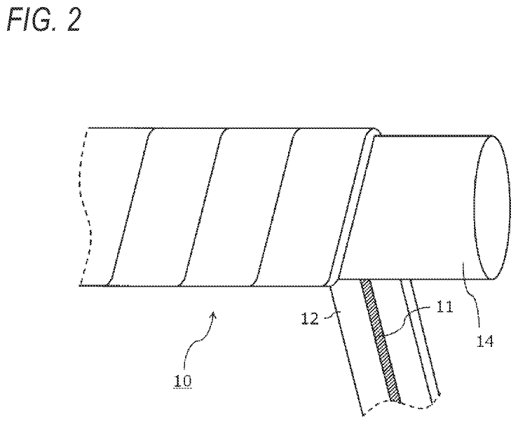

In FIG. 1A, an example of performing winding to make the side where the linear adhesive body 11 is disposed on the inner side is shown, but the winding may be performed to make the side where the linear adhesive body 11 is disposed on the outer side. As shown in FIG. 2, the release liner-attached adhesive body 10 according to the present embodiment may be wound around a reel 14 and the like. The release liner-attached adhesive body 10 according to the present embodiment may not be wound, and for example, the linear adhesive body 11 may be sandwiched by a plurality of release liners 12.

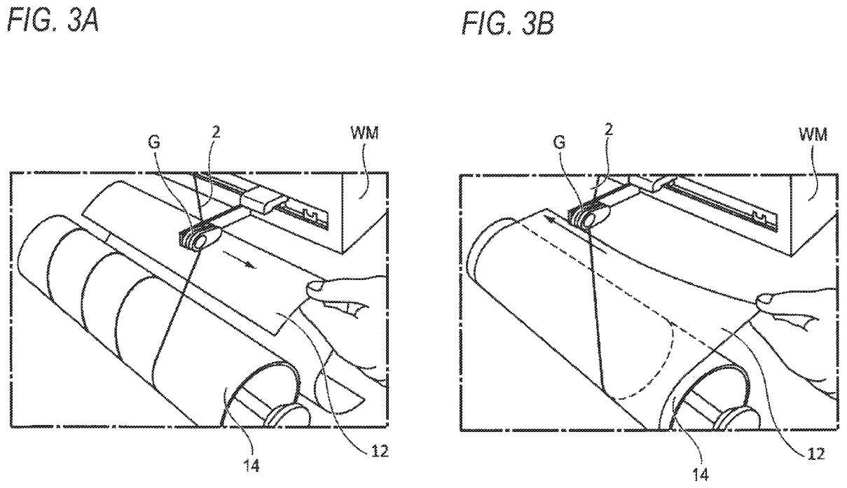

For example, the release liner-attached adhesive body 10 is wound into a roll shape as follows. FIG. 3A and FIG. 3B show diagrams showing a specific example of a method of winding the release liner-attached adhesive body 10 in which the adhesive body is threadlike (which is a threadlike adhesive body). As shown in FIG. 3A and FIG. 3B, a threadlike adhesive body 11 is traverse-wound (twill-wound) around the reel 14 over a predetermined width by a guide G of a winding machine WM reciprocating in a width direction of the reel 14 (paper tube, winding core). As shown in FIG. 3A, when the threadlike adhesive body 11 comes to a right (or left) end of the reel 14 in the width direction, the release liner 12 is sandwiched. The release liner 12 is a sheet (single wafer) having a size having a width at least the predetermined width and a length at least an outer circumference of the reel 14. The upper limit of the length of the release liner 12 is preferably about twice the outermost circumference during the winding, that is, the outermost circumference when the threadlike adhesive body 11 and the release liner 12 are wound around the reel 14, from the viewpoint of convenience. As shown in FIG. 3B, when the guide G moves in the width direction, the threadlike adhesive body 11 is wound around the reel 14 in a roll shape via the release liner 12. The sandwiching of the release liner 12 shown in FIG. 3A is preferably performed automatically.

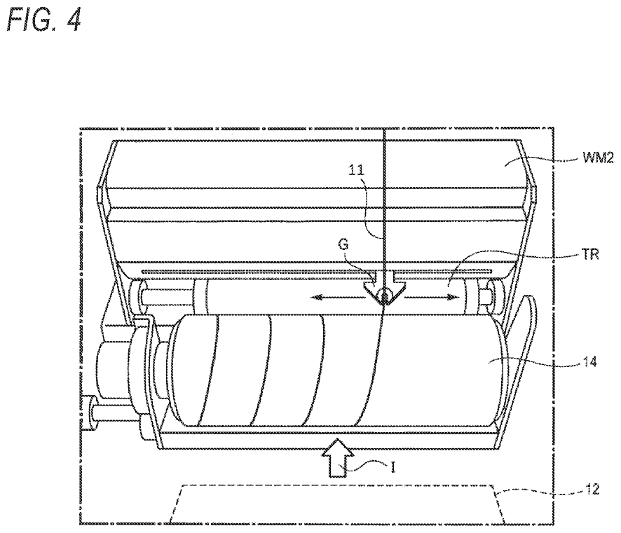

For winding the release liner-attached adhesive body, a winding machine WM2 shown in FIG. 4 may be used instead of the winding machine WM shown in FIG. 3A and FIG. 3B. The winding machine WM2 is a machine that added a touch roll portion TR to the winding machine WM. The touch roll portion TR is provided parallel to the reel 14 below the guide G that reciprocates in the width direction of the reel 14, and presses the surface of the reel 14 (via the threadlike adhesive body 11 and the release liner 12). When the threadlike adhesive body 11 comes to the right (or left) end of the reel 14 in the width direction, the release liner 12 is inserted in a direction indicated by an arrow I, the release liner 12 is positioned between the reel 14 and the touch roll portion TR, and the release liner 12 is sandwiched therebetween. In this state, when the guide G moves in the width direction, the threadlike adhesive body 11 is wound around the reel 14 in a roll shape via the release liner 12. During the winding, when the release liner 12 is pressed against the reel 14 with the touch roll portion TR, the release liner-attached adhesive body can be wound up without loosening.

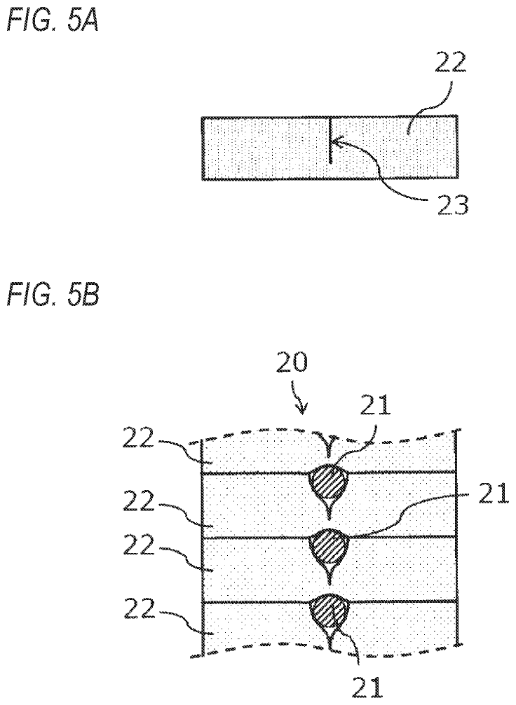

In the release liner-attached adhesive body according to the present embodiment, similar to the second embodiment described later, it is preferable that a slit is formed in the release liner and at least a part of the adhesive body is disposed in the slit. FIG. 5A shows a cross-sectional view of a cross section of a release liner 22 formed with a slit 23, which is perpendicular to a longitudinal direction thereof. FIG. 5B shows a cross-sectional view of a cross section of a roll around which a release liner-attached adhesive body 20 including the release liner 22 formed with the slit 23 is wound (a roll-shaped release liner-attached adhesive body 20), which is perpendicular to a winding direction.

In such a configuration, since at least a part of a linear adhesive body 21 is disposed in the slit 23, the stress received by the linear adhesive body 21 from the release liner 22 during the winding is further alleviated, and crushing is more difficult to occur. In addition, since the linear adhesive body 21 is held in the slit 23, it is more difficult to roll.

A preferred form of the slit 23 is the same as that described in the section of the second embodiment to be described later.

The material of the release liner in the present embodiment is not particularly limited as long as it has the above compression elastic modulus. From the viewpoint that a high cushioning property can be easily obtained, the release liner in the present embodiment is preferably a release liner mainly made of a porous material. Here, the expression “a release liner mainly made of a porous material” means that it is a release liner made of only a porous material, or that it is a laminate including a layer made of a porous material and another layer.

Examples of the porous material include the following (1) to (3).

(1) Paper, woven fabric, and non-woven fabric (e.g., polyester (e.g., polyethylene terephthalate (PET)) non-woven fabric).

(2) A material obtained by mechanically perforating a solid film containing one or more resins selected from the group consisting of a polyester (e.g., polyethylene terephthalate (PET)), nylon, Saran (trade name), polyvinyl chloride, polyethylene, polypropylene, an ethylene-vinyl acetate copolymer, polytetrafluoroethylene, and an ionomer.

(3) Foam materials such as polyolefin foams (e.g., a non-cross-linked polyethylene foam, a cross-linked polyethylene foam, a polypropylene foam, and a foam containing polyethylene (PE) and polypropylene (PP)), polyester foams (e.g., a polyethylene terephthalate foam), urethane foams (e.g., a soft urethane foam, a hard urethane foam, a urethane-modified a polyisocyanurate foam, and a polyisocyanurate foam), or rubber foams.

Among these, a foam material is preferred, and a polyolefin foam material is more preferred, because the cushioning property is good.

The porous material preferably has an apparent density of 900 kg/m³ or less, and more preferably 200 kg/m³ or less, as measured in accordance with JIS K 7222 (2005). When the porous material has such an apparent density, a release liner 22 having a particularly excellent cushioning property can be obtained.

On the other hand, from the viewpoint of strength, the apparent density of the porous material is preferably 15 kg/m³ or more, and more preferably 25 kg/m³ or more.

When the porous material is a foam material, it is preferable that an average major axis of micropores is in the range of 10 μm to 1000 μm and the average minor axis of the micropores is in the range of 10 μm to 1000 μm. A porosity in the foam material is preferably 50% to 99%, and more preferably 60% to 98% from the viewpoint of flexibility. Here, the term “porosity” means an area ratio of micropores in an area of the material in a plane perpendicular to a thickness direction of the foam material.

In addition, the release liner may be provided with another layer other than the layer made of a porous material, and examples of another layer include a metal-made or resin-made solid film, a skin layer, and a release layer.

The metal-made or resin-made solid film is a non-perforated film made of a metal or a resin that has not been mechanically perforated, and may be provided to suppress elongation of the release liner. When the elongation of the release liner is suppressed, there are advantages such as easy transportation and easy uniform application of a release treatment agent. The “solid film” also includes a metal-made or resin-made film having micropores inevitably generated in the production stage of forming a metal or resin into a film. Examples of the resin-made solid film include a film made of one or more resins selected from the group consisting of: polyesters (e.g., polyethylene terephthalate (PET) and polyethylene naphthalate (PEN)); polyamide (e.g., nylon); polyvinyl chloride (PVC); polyvinyl acetate (PVAc); polyvinylidene chloride; polyolefins (e.g., polyethylene (high density polyethylene and low density polyethylene), polypropylene, reactor TPO, an ethylene-propylene copolymer, and an ethylene-vinyl acetate copolymer (EVA)); polyimide (PI); fluorine-based resins (e.g., polytetrafluoroethylene); and cellophane and ionomer resins (e.g., a resin obtained by cross-linking a polymer having a polyethylene unit (E) and an acrylic acid unit (A) with a metal (M)). Examples of the metal-made solid film include aluminum foil, copper foil, and stainless steel foil.

The solid film is preferably a resin-made solid film, more preferably a film made of one or more resins selected from the group consisting of polyolefins, polyesters, and polyimides, and still more preferably a film made of one or more resins selected from the group consisting of polyethylene (high density polyethylene and low density polyethylene), polypropylene, an ethylene-propylene copolymer, an ethylene-vinyl acetate copolymer, and polyethylene terephthalate.

A thickness of the metal-made or resin-made solid film is preferably 3 μm to 80 μm, more preferably 3 μm to 50 μm, and still more preferably 10 μm to 50 μm, from the viewpoints of maintaining the cushioning property of the release liner and stable formation of a release layer to be described later.

Lamination of a solid film on a layer made of a porous material is performed by a known method for laminating a laminated film, such as hot pressing with a hot press machine or continuous heat laminating with roll-to-roll.

The “skin layer” is a porous thin layer having a porosity smaller than a porosity of the layer made of a porous material, which is formed on the surface of the layer made of a porous material, and may be provided to suppress the elongation of the release liner. The “porosity” is the area ratio of micropores in the area of the thin layer on a plane perpendicular to the thickness direction of the layer made of a porous material. The porosity of the skin layer is preferably 10% or less, and more preferably 5% or less, from the viewpoints of maintaining the cushioning property of the layer made of a porous material and the stable formation of the release layer to be described later. A thickness of the skin layer is preferably 3 μm to 50 μm, and more preferably 3 μm to 20 μm, from the viewpoints of maintaining the cushioning property of the release liner and the stable formation of the release layer to be described later.

The skin layer is formed, for example, by melting a surface layer portion of the layer made of a porous material. For example, the skin layer can be formed on a contact surface side of the layer made of a porous material with a heating roll by using the heating roll set to a temperature about 5° C. to 20° C. lower than the melting point of the porous material, and reducing a rotation speed of the heating roll to be lower than a traveling speed of the layer made of a porous material.

The release layer is a layer formed on a contact surface between the release liner and the adhesive body and is difficult to be adhered to the adhesive body, and may be provided to facilitate the peeling between the release liner and the adhesive body. The release layer can be formed, for example, by applying a release treatment agent (release agent) to the surface of the release liner and performing curing.

The release treatment agent (release agent) used for forming the release layer is not particularly limited, and a fluorine-based release agent, a long-chain alkyl acrylate-based release agent, a silicone-based release agent, or the like is used. Among these, a silicone-based release agent is preferred, and as a curing method, it is preferable to use a curing method such as ultraviolet irradiation or electron beam irradiation. Further, among the silicone-based release agent, an ultraviolet curable type silicone-based release agent having cationically polymerizability is preferred. The ultraviolet curable type silicone-based release agent having cationically polymerizability is a mixture containing cationically polymerizable silicone (polyorganosiloxane having an epoxy functional group in the molecule) and an onium salt-based photoinitiator, is particularly preferably one in which the onium salt-based photoinitiator is composed of a boron-based photoinitiator. By using such a ultraviolet curable type silicone-based release agent having cationically polymerizability in which the onium salt-based photoinitiator is composed of a boron-based photoinitiator, particularly good releasability can be obtained. The cationically polymerizable silicone (polyorganosiloxane having an epoxy functional group in the molecule) has at least two epoxy functional groups in one molecule and may be linear, branched or a mixture thereof. The type of the epoxy functional group in the polyorganosiloxane is not particularly limited, and may be any one in which ring-opening cationic polymerization proceeds by using an onium salt-based photoinitiator. Specific examples include a γ-glycidyloxypropyl group, a β-(3,4-epoxycyclohexyl)ethyl group, and a β-(4-methyl-3,4 epoxycyclohexyl)propyl group. Such cationically polymerizable silicone (polyorganosiloxane having an epoxy functional group in the molecule) is available on the market, and commercially available products can be used. Examples include UV9315, UV9430, UV9300, TPR6500, and TPR6501 manufactured by Toshiba Silicone Co., Ltd., X-62-7622, X-62-7629, X-62-7655, X-62-7660, and X-62-7634A manufactured by Shin-Etsu Chemical Co., Ltd., and Poly200, Poly201, RCA200, RCA250, and RCA251 manufactured by Arakawa Chemical Industries, Ltd.

In addition, as the silicone-based release agent, a thermosetting addition-type silicone-based release agent (thermosetting addition-type polysiloxane-based release agent) can also be used. The thermosetting addition-type silicone-based release agent contains a polyorganosiloxane having an alkenyl group as a functional group in the molecule (silicone having an alkenyl group) and a polyorganosiloxane having a hydrosilyl group as a functional group in the molecule as essential constituents.

As the polyorganosiloxane having an alkenyl group as a functional group in the molecule, a polyorganosiloxane having two or more alkenyl groups in the molecule is preferred. Examples of the alkenyl group include a vinyl group (ethenyl group), an allyl group (2-propenyl group), a butenyl group, a pentenyl group, and a hexenyl group. The above alkenyl group is generally bonded to a silicon atom of a polyorganosiloxane forming a main chain or a skeleton (for example, a silicon atom at the terminal or a silicon atom inside the main chain).

Examples of the polyorganosiloxane forming a main chain or a skeleton include polyalkylalkylsiloxanes (polydialkylsiloxanes) such as polydimethylsiloxane, polydiethylsiloxane, and polymethylethylsiloxane, polyalkylarylsiloxanes, and a copolymer in which multiple types of silicon atom-containing monomer components are used (e.g., poly(dimethylsiloxane-diethylsiloxane)). Among these, polydimethylsiloxane is preferred. That is, as the polyorganosiloxane having an alkenyl group as a functional group in the molecule, specifically, polydimethylsiloxane having a vinyl group, a hexenyl group or the like as a functional group is preferably exemplified.

The above polyorganosiloxane crosslinking agent having a hydrosilyl group as a functional group in the molecule is a polyorganosiloxane having a hydrogen atom bonded to a silicon atom (particularly a silicon atom having a Si—H bond) in the molecule, and is preferably a polyorganosiloxane having two or more silicon atoms having a Si—H bond in the molecule. The above silicon atom having a Si—H bond may be either a silicon atom in the main chain or a silicon atom in the side chain, that is, may be included as a constituent unit of the main chain, or may be included as a constituent unit of the side chain. The number of silicon atoms in the Si—H bond is not particularly limited as long as it is two or more. As the above polyorganosiloxane crosslinking agent having a hydrosilyl group as a functional group in the molecule, specifically, polymethylhydrogensiloxane, poly(dimethylsiloxane-methylhydrogensiloxane) and the like are preferred.

As a thermosetting silicone-based release treatment agent, a reaction inhibitor (reaction retarder) may be used in order to impart storage stability at room temperature together with the thermosetting silicone-based resin. When a thermosetting addition-type silicone-based release agent is used as the release agent, examples of the reaction inhibitor include 3,5-dimethyl-1-hexyne-3-ol, 3-methyl-1-pentene-3-ol, 3-methyl-3-pentene-1-yne, and 3,5-dimethyl-3-hexene-1-yne.

In addition, in the thermosetting silicone-based release treatment agent, a release control agent or the like may be used, if necessary, in addition to the above components. Specifically, a release control agent such as MQ resin, a polyorganosiloxane having no alkenyl group or hydrosilyl group (trimethylsiloxy group-terminated blocking polydimethylsiloxane, etc.) may be added. The content of these components in the release treatment agent is not particularly limited, and is preferably 1 mass % to 30 mass % with respect to the total solid content.

The thermosetting silicone-based release treatment agent generally contains a curing catalyst. As the curing catalyst, it is preferable to use a platinum-based catalyst generally used as a catalyst for thermosetting addition-type silicone. Among these, at least one platinum-based catalyst selected from chloroplatinic acid, a platinum olefin complex, and a chloroplatinic acid olefin complex is preferred. The curing catalyst can be used as it is or in a form dissolved or dispersed in a solvent.

The blending amount (solid content) of the curing catalyst is preferably 0.05 to 0.55 parts by mass, and more preferably 0.06 to 0.50 parts by mass with respect to 100 parts by mass (resin content) of the thermosetting silicone-based resin. When the blending amount of the curing catalyst is less than 0.05 parts by mass, the curing rate is slow, and when the blending amount is more than 0.55 parts by mass, the pot life is greatly shortened.

An organic solvent is generally used in a coating liquid containing the release treatment agent used when providing the release layer in order to improve the coatability. The organic solvent is not particularly limited, and for example, aliphatic or alicyclic hydrocarbon solvents such as cyclohexane, hexane, and heptane, aromatic hydrocarbon solvents such as toluene and xylene, ester solvents such as ethyl acetate and methyl acetate, ketone solvents such as acetone and methyl ethyl ketone, and alcoholic solvents such as methanol, ethanol and butanol can be used. The organic solvent may be used alone or in combination of two or more thereof.

A thickness of the release layer is preferably 0.001 μm to 10 μm, more preferably 0.03 μm to 5 μm, and particularly preferably 0.1 μm to 1 μm from the viewpoints of excellent releasability and suppression of a thickness unevenness (stable formation of the release layer).

As the release liner in the present embodiment, a film subjected to an unevenness treatment can also be preferably used.

Here, surface roughness (Ra) of the film subjected to the unevenness treatment is preferably 0.05 μm or more, and more preferably 0.07 μm or more, from the viewpoint of a shape retention property of the threadlike adhesive. In addition, the surface roughness (Ra) is preferably 50 μm or less, and more preferably 30 μm or less, since the threadlike adhesive tends to move easily during storage. The surface roughness (Ra) of the film subjected to the unevenness treatment can be measured by a stylus type surface roughness measuring instrument (for example, high-precision fine shape measuring instrument, product name “Surfcorder ET4000” manufactured by Kosaka Laboratory Ltd.) based on JIS B 0601 (1994 version).

Examples of an unevenness treatment method include embossing and blasting. A temporary support may be coated with a composition containing a binder resin and particles and then the composition is cured to form an uneven surface on the temporary support. In addition, a known method can be used, and for example, screen printing, gravure printing, or transfer by nanoimprint may be used. Among these, embossing is particularly preferred because it is easy to obtain the desired releasability.

The material of the film to be subjected to the unevenness treatment is not particularly limited as long as it satisfies the above compression elastic modulus, and may be appropriately selected depending on the desired releasability, hardness and the like.

For example, paper, a resin film, a metal foil, or the like that has been subjected to the unevenness treatment can be used.

As a resin forming the film, for example, a polyester resin, a polyolefin resin, a polyamide resin, a polyimide resin, a polyphenylene sulfide resin, a polycarbonate resin, a polyurethane resin, an ethylene-vinyl acetate resin, a fluorine-based resin such as polytetrafluoroethylene, and an acrylic resin such as polymethyl methacrylate can be used. The resin film may be formed by using a resin material containing one kind of such a resin alone, or may be formed by using a resin material in which two or more kinds are blended. Further, the resin film may be unstretched or stretched (uniaxially stretched or biaxially stretched).

The film subjected to the unevenness treatment can be subjected to a release treatment, if necessary. The release treatment is the same as the release treatment applied to the above release liner mainly composed of a porous material.

The thickness of the release liner in the present embodiment is not particularly limited as long as it has the above compression elastic modulus, and is preferably 10 μm or more, and more preferably 20 μm or more, from the viewpoint of handleability. The upper limit of the thickness of the release liner in the present embodiment is not particularly limited, and may be, for example, 10,000 μm or less. From the viewpoint of cost, the upper limit of the thickness is preferably 1,000 μm or less, and more preferably 700 μm or less.

The adhesive body in the present embodiment is not particularly limited as long as it is linear. The cross-sectional shape of the adhesive body in the present embodiment is a circle in FIG. 1B, but the shape is not limited to this, and various shapes such as an ellipse, a rectangle such as a quadrangle, and the like can be formed in addition to the circle.

A thickness of the adhesive body in the present embodiment is not particularly limited, and a thickness suitable for the intended use can be selected, and is generally about 0.01 mm to 3 mm

In addition, a length of the adhesive body in the present embodiment is not particularly limited, and a length suitable for the intended use can be selected.

The adhesive body in the present embodiment may include a core material and a layer (adhesive layer) made of an adhesive that covers the core material. The adhesive body may not include a core material and may consist only of an adhesive.

The adhesive forming the adhesive body in the present embodiment is not particularly limited, and a known adhesive can be used. Examples of the adhesive include an acrylic adhesive, a rubber-based adhesive, a vinyl alkyl ether-based adhesive, a silicone-based adhesive, a polyester-based adhesive, a polyamide-based adhesive, a urethane-based adhesive, a fluorine-based adhesive, and an epoxy-based adhesive. Among these, from the viewpoint of adhesiveness, a rubber-based adhesive and an acrylic adhesive are preferred, and an acrylic adhesive is particularly preferred. The adhesive may be used alone or in combination of two or more thereof.

The acrylic adhesive is an adhesive containing, as a main component, a (meth)acrylic acid alkyl ester such as ethyl acrylate, butyl acrylate, 2-ethylhexyl acrylate, isooctyl acrylate, and isononyl acrylate, and, as a main agent, a polymer of monomers obtained by adding a modifying monomer, such as acrylonitrile, vinyl acetate, styrene, methyl methacrylate, acrylic acid, maleic anhydride, vinylpyrrolidone, glycidyl methacrylate, dimethylaminoethyl methacrylate, hydroxyethyl acrylate, and acrylamide, to the above (meth)acrylic acid alkyl ester, if necessary.

The rubber-based adhesive is an adhesive containing, as a main agent, a rubber-based polymer such as a natural rubber, a styrene-isoprene-styrene block copolymer, a styrene-butadiene-styrene block copolymer, a styrene-ethylene butylene-styrene block copolymer, a styrene butadiene rubber, polybutadiene, polyisoprene, polyisobutylene, a butyl rubber, a chloroprene rubber, and a silicone rubber.

These adhesives may be appropriately blended with tackifying resins such as rosin-based one, terpene-based one, styrene-based one, aliphatic petroleum-based one, aromatic petroleum-based one, xylene-based one, phenol-based one, kumaron inden-based one, and hydrogenated additives thereof, and various additives such as a crosslinking agent, a viscosity modifier (thickener), a leveling agent, a release modifier, a plasticizer, a softener, a filler, a coloring agent (pigments, dyes or the like), a surfactant, an antistatic agent, a preservative, an age resister, a UV absorber, an antioxidant, and a light stabilizer.

As the adhesive, either a solvent type adhesive or a water-dispersible type adhesive may be used. Here, from the viewpoints of enabling high-speed coating, being environmentally friendly, and having a small influence (swelling or dissolving) on the core material caused by the solvent, a water-dispersible type adhesive is preferred.

The adhesive body in the present embodiment is preferably a pressure-sensitive adhesive body. That is, the adhesive forming the adhesive body in the present embodiment is preferably a pressure-sensitive adhesive. When a pressure-sensitive adhesive is used as the adhesive forming the adhesive body, the workability when sticking the adhesive body to a target (adherend) is excellent. Further, for example, when a hot melt adhesive is used, heating is required in sticking the adhesive body to the adherend, and the adherend may deteriorate at this time. However, use of a pressure-sensitive adhesive is preferred in that there is no risk of such deterioration.

When the adhesive body in the present embodiment includes a core material, the material of the core material is not particularly limited, and can be appropriately selected depending on the required properties such as strength, weight, and hardness. For example, a resin, a rubber, a foam, an inorganic fiber, or a composite of these materials can be used as the material of the core material. Examples of the resin include: polyolefins such as polyethylene (PE), polypropylene (PP), an ethylene-propylene copolymer, and an ethylene-vinyl acetate copolymer; polyesters such as polyethylene terephthalate (PET); a vinyl chloride resin; a vinyl acetate resin; a polyimide resin; a polyamide resin; and a fluorine-based resin. Examples of the rubber include a natural rubber, and a synthetic rubber such as a urethane rubber. Examples of the foam include a polyurethane foam and a foamed polychloroprene rubber. Examples of the fiber include glass fibers, carbon fibers, and metal fibers. Further, the cross-sectional shape of the core material is also not particularly limited.

It is preferable that the adhesive body in the present embodiment is threadlike, since the adhesive body can be disposed in various shapes such as a curved shape on the adherend.

As a material of a threadlike core material that can be used for the threadlike adhesive body, various polymer materials such as rayon, cupra, acetate, promix, nylon, aramide, vinylon, vinylidene, polyvinyl chloride, polyester, acryl, polyethylene, polypropylene, polyurethane, polychlal and polylactic acid; glasses; carbon fibers; various rubbers such as a natural rubber and synthetic rubbers made of a polyurethane or the like; natural materials such as cotton and wool; and metals can be used. As the form of the threadlike core material, for example, monofilaments, multifilaments, span yarns, finished yarns generally called textured yarn, bulky yarn and stretched yarn that have been subjected to crimping or bulking or combined yarns obtained by, for example, twisting those can be used. The cross-sectional shape is not limited to only a circle, and can be a rectangular shape such as a square shape, a star shape, an elliptical shape, a hollow shape, and the like.

When the adhesive body is a threadlike adhesive body, it is thinner and more easily deformed than other linear members such as cables, so it is preferable that the release liner is easily deformed even at a low stress such as a compression stress of 0.01 MPa. Therefore, the compression strain value ε2 under the compression stress 62 of 0.01 MPa is preferably 0.01 or more, and more preferably 0.02 or more.

The core material may contain various additives such as a filler (inorganic filler, organic filler or the like), an age resister, an antioxidant, a UV absorber, an antistatic agent, a lubricant, a plasticizer, and a coloring agent (pigments, dyes or the like). A known or common surface treatment such as a corona discharge treatment, a plasma treatment or application of an undercoat agent may be performed on the surface of the core material.

When the adhesive body in the present embodiment includes a core material and an adhesive layer, an adhesion amount of the adhesive (weight of the adhesive layer per unit length) is not particularly limited and may be appropriately determined according to the type of member to be stuck and the intended use. From the viewpoint of adhesiveness, for example, the adhesion amount of the adhesive is preferably 2 mg/m or more, more preferably 5 mg/m or more, and still more preferably 8 mg/m or more. On the other hand, when the adhesion amount of the adhesive is excessive, it is necessary to apply the adhesive to the core material a plurality of times in the production process, or it takes time to dry the applied adhesive, resulting in a low production efficiency. Therefore, the adhesion amount of the adhesive is preferably 200 mg/m or less, more preferably 180 mg/m or less, and still more preferably 160 mg/m or less.

A thickness of the core material is not particularly limited, and may be appropriately determined according to the type of member to be stuck and the intended use, for example, about 20 dtex to 2,000 dtex.

In addition, when the adhesive body in the present embodiment includes a core material and an adhesive layer, the adhesive layer may cover the entire surface of the core material (the surface in the longitudinal direction), or may cover only a part of the surface of the core material. The adhesive layer is typically formed continuously, but is not limited to such a form, and may be formed in a regular pattern such as a dot shape or a stripe shape or random pattern. An end surface of the core material may or may not be covered with the adhesive layer. For example, when an adhesive article is cut during the production process or the use, the end surface of the core material may not be covered with the adhesive layer.

The adhesive body not including a core material can be obtained, for example, by preparing an adhesive, applying the adhesive linearly on the release liner using a dispenser, and performing heating and drying if necessary.

The adhesive body including a core material can be obtained by coating the core material with an adhesive by using known coaters such as a gravure roll coater, a reverse roll coater, a kiss roll coater, a dip roll coater, a bar coater, a knife coater, and a spray coater, and appropriately performing heating and drying.

### Second Embodiment

A release liner-attached adhesive body according to a second embodiment of the present invention includes a linear adhesive body and a release liner, in which a slit is formed in the release liner, and at least a part of the adhesive body is disposed in the slit.

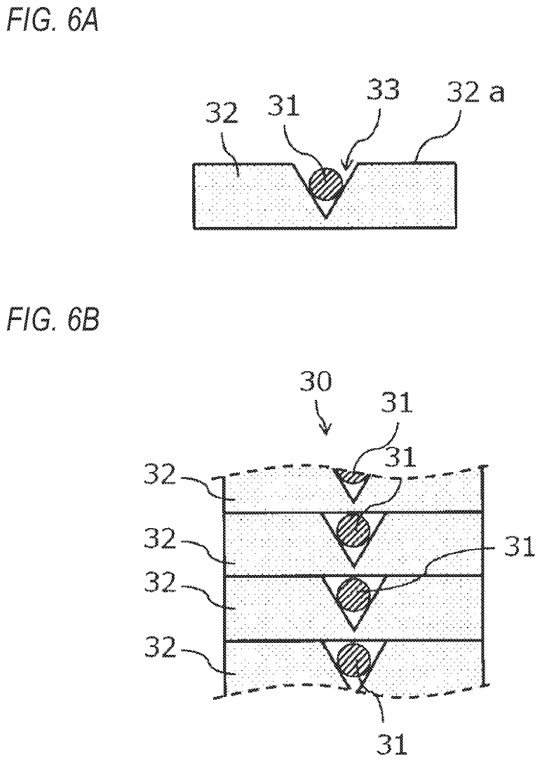

FIG. 6A shows a cross-sectional view of a cross section of a release liner-attached adhesive body 30 according to the present embodiment, which is perpendicular to a longitudinal direction thereof. FIG. 6B shows a cross-sectional view of a cross section of a roll around which the release liner-attached adhesive body 30 according to the present embodiment is wound (a roll-shaped release liner-attached adhesive body 30), which is perpendicular to a winding direction.

In the release liner-attached adhesive body 30 according to the present embodiment, since at least a part of a linear adhesive body 31 is disposed in a slit 33, the linear adhesive body 31 is less likely to receive a pressure from a release liner 32 and is less likely to be crushed even in the case of winding. In addition, in the present embodiment, since at least a part of the linear adhesive is disposed in the slit, the linear adhesive body is difficult to fall off.

The shape, width, depth, etc. of the slit in the present embodiment are not particularly limited as long as at least a part of the adhesive body can be disposed in the slit.

In order to further reduce the pressure applied to the adhesive body from the release liner and make the adhesive body more difficult to crush, it is preferable that the shape, width, depth, etc. of the slit are configured such that the entire adhesive body can be disposed in the slit. That is, the slit 33 in the present embodiment is preferably configured such that, in the cross-sectional view of the cross section of the adhesive body 31 in a disposed state (not in a wound state) perpendicular to the longitudinal direction, the adhesive body 31 does not protrude from a surface 32a on the side where the slit 33 of the release liner 32 is formed, as in the configuration example shown in FIG. 6A and FIG. 6B. Examples of the cross-sectional shape of such a slit include a V-shape, a U-shape, an arc shape, and a concave shape.

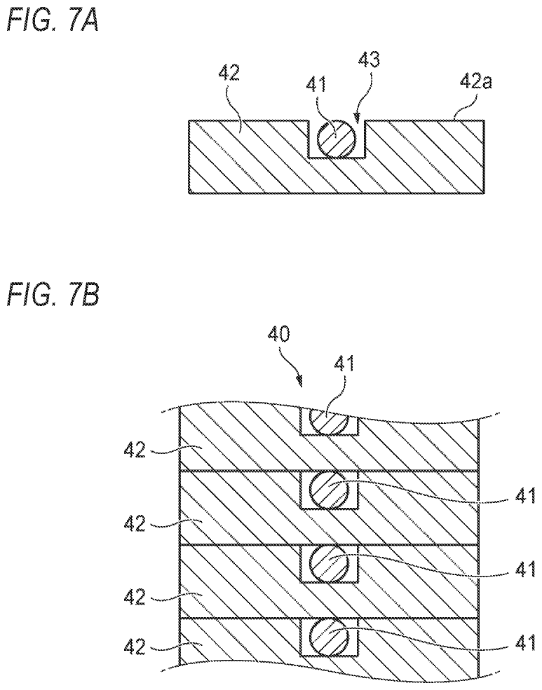

For example, in the configuration example shown in FIG. 6A, the cross-sectional shape of the slit 33 is a V-shape, and in the configuration example shown in FIG. 7A, the cross-sectional shape of a slit 43 is a concave shape. In the configuration example shown in FIG. 7A and FIG. 7B, a release liner-attached adhesive body 40 is also preferably configured such that an adhesive body 41 does not protrude from a surface 42a on the side where a slit 43 of a release liner 42 is formed.

The cross-sectional shape of the slit is not limited to a straight line or a curved line, and may be formed in a zigzag line or a wavy line.

On the other hand, from the viewpoint of productivity, it is preferable that the slit is configured as a simple notch as shown in FIG. 5A, for example.

It is preferable that the slit is formed along the longitudinal direction of the release liner since it is easy to wind the release liner-attached adhesive body into a roll shape.

In the present embodiment, the number of slits formed in the release liner is not particularly limited, and may be one or two or more. Further, the slit may be formed in only one side of the release liner, or may be formed on both sides.

The compression elastic modulus of the release liner in this embodiment is not particularly limited. In order to further alleviate the stress received by the adhesive body from the release liner and to make the adhesive body more difficult to crush, it is also preferable that the release liner has a high cushioning property in the present embodiment. From this viewpoint, it is preferable that the release liner in the present embodiment also has a compression elastic modulus of 1.5 MPa or less, similar to the first embodiment.

In addition, the material of the release liner in the present embodiment is also not particularly limited. From the viewpoint that a high cushioning property can be easily obtained, the release liner in the present embodiment is preferably a release liner mainly made of a porous material, similar to the first embodiment. As the porous material, for example, those exemplified in the section of the first embodiment can be used.

The release liner in the present embodiment may include a metal-made or resin-made solid film, a skin layer, and a release layer, similar to the release liner in the first embodiment. The adhesive body in the present embodiment is not particularly limited as long as it is threadlike, and the adhesive body same as that described in the section of the first embodiment can be used.

In the use of the release liner-attached adhesive body according to the above embodiments, for example, the adhesive body can be peeled off from the release liner and stuck to an adherend. Alternatively, the release liner-attached adhesive body can be stuck to an adherend for each release liner and then the release liner can be peeled off, that is, the adhesive body can be transferred to the adherend.

Hereinafter, a transfer method when a threadlike adhesive body is used as the adhesive body will be described. First, an adhesive surface of the threadlike adhesive body stuck to the release liner is brought into contact with the adherend, and the threadlike adhesive body is pressed against the adherend via the release liner by a roller, a finger or the like for adhesion.

Thereafter, the release liner is released and removed from the threadlike adhesive body adhered to the adherend to expose the threadlike adhesive body. In this way, the threadlike adhesive body is stuck to the adherend in a desired shape.

In order to ensure that the threadlike adhesive body is transferred, that is, in order to prevent the threadlike adhesive body from releasing from the adherend and remaining on the release liner, the release liner is preferably released from the adherend by peeling, and the peeling angle at this time is preferably 5° or more, more preferably 10° or more, and still more preferably 20° or more. When releasing the release liner from the adherend by peeling, the release liner may be released off while being deformed, the adherend may be released while being deformed, or both the release liner and the adherend may be released while being deformed. A suitable releasing method may be appropriately selected according to the hardness (deformability) of the release liner and the adherend.

As described above, the threadlike adhesive body is formed (drawn) on the release liner into an inverted shape of a desired shape and then transferred to stick the threadlike adhesive body to the adherend in the desired shape. Accordingly, the threadlike adhesive body can be easily stuck to the adherend even when the sticking shape is complicated.

Based on such a feature, the method of sticking the threadlike adhesive body by transfer is suitable as, for example, a method of sticking the threadlike adhesive body for fixing a cable such as an electric wire or an optical fiber, a LED fiber light, optical fiber sensors such as fiber Bragg gratings (FBG), various wires (linear members) such as a yarn, a string, or a wire, or a narrow member in a desired form. Even in the case of fixing a wire or a narrow member to another member having a complicated shape, with the method of sticking the threadlike adhesive body by transfer, the threadlike adhesive body can be easily stuck to a member to which a wire or a narrow member is stuck according to a complicated shape of the wire or the narrow member.

For example, if the threadlike adhesive body is used for temporary fixing when sewing fiber products or leather products such as clothes, shoes, bags, or hats, it is easy to temporarily fix the threadlike adhesive body while avoiding a sewn portion, and it is possible to easily prevent the adhesive from adhering to the needle. When an article to be sewn has a complicated shape or is easily deformed, it may not be easy to stick the threadlike adhesive body. However, even in such a case, the threadlike adhesive body can be easily stuck by the method of sticking the threadlike adhesive body by transfer.

### EXAMPLES

Hereinafter, the present invention will be described in detail with reference to Examples, but the present invention is not limited to these Examples.

### (Preparation of Adhesive)

Into a reaction vessel equipped with a cooling tube, a nitrogen introduction tube, a thermometer, and a stirrer, 40 parts by mass of ion-exchanged water was added, and stirring was performed at 60° C. for 1 hour or longer while introducing nitrogen gas to carry out nitrogen substitution. To this reaction vessel, 0.1 parts by mass of 2,2′-azobis[N-(2-carboxyethyl)-2-methylpropionamidine] n hydrate (polymerization initiator) was added. While the system was maintained at 60° C., a monomer emulsion A was gradually added dropwise thereto over 4 hours to allow an emulsion polymerization reaction to proceed.

As the monomer emulsion A, used as an emulsion obtained by adding and emulsified 98 parts by mass of 2-ethylhexyl acrylate, 1.25 parts by mass of acrylic acid, 0.75 parts by mass of methacrylic acid, 0.05 parts by mass of lauryl mercaptan (chain transfer agent), 0.02 parts by mass of γ-methacryloxypropyltrimethoxysilane (trade name: “KBM-503”, manufactured by Shin-Etsu Chemical Co., Ltd.), and 2 parts by mass of sodium polyoxyethylene lauryl sulfate (emulsifier) to 30 parts by mass of ion-exchanged water. After completion of the dropwise addition of the monomer emulsion A, the system was further kept at 60° C. for 3 hours and cooled to room temperature, and the pH was then adjusted to 7 by addition of 10% ammonia water to obtain an acrylic polymer emulsion (water-dispersible acrylic polymer).

A tackifying resin emulsion (trade name: “E-865NT”, manufactured by Arakawa Chemical Industries, Ltd.) was added in an amount of 20 parts by mass based on the solid content per 100 parts by mass of the acrylic polymer contained in the above acrylic polymer emulsion. Further, the pH was adjusted to 7.2 and the viscosity was adjusted to 10 Pa s using 10 mass % ammonia water as a pH adjuster and polyacrylic acid (trade name: “ARON B-500”, manufactured by Toagosei Co., Ltd.) as a thickener. Accordingly, a water-dispersible acrylic adhesive was obtained.

### (Preparation of Adhesive Body)

A multifilament yarn (280 dtex) in which 48 polyester yarns (filaments) were twisted 150 times/m was used as a core material. The core material was coated with the water-dispersible acrylic adhesive obtained above by dipping such that the adhesion amount of the adhesive in the obtained adhesive body was 22 mg/m, and then dried at 80° C. for 5 minutes to form an adhesive layer, thereby obtaining an adhesive body (threadlike adhesive body).

### Example 1

As the release liner, a polyethylene foam base material (PE, manufactured by Nitto Denko Corporation) having a length of 4 cm, a width of 4 cm, and a thickness of 0.5 mm was prepared. From one side to the opposite side of the release liner, a threadlike adhesive body having a length of 4 cm prepared as described above was stuck to obtain a release liner-attached adhesive body in Example 1.

### Example 2

A release liner-attached adhesive body in Example 2 was obtained in the same manner as in Example 1, except that an embossed polyurethane film (surface roughness Ra: 0.2 μm) having a length of 4 cm, a width of 4 cm, and a thickness of 0.3 mm was used as the release liner.

### Example 3

A release liner-attached adhesive body in Example 3 was obtained in the same manner as in Example 1, except that foamed polyethylene P1005 (manufactured by Fuji Gomu Co., Ltd.) having a length of 4 cm, a width of 4 cm, and a thickness of 10 mm was used as the release liner.

### Example 4

A release liner-attached adhesive body in Example 4 was obtained in the same manner as in Example 1, except that rubber sponge NR33 (manufactured by Inoac Corporation) having a length of 4 cm, a width of 4 cm, and a thickness of 5 mm was used as the release liner.

### Example 5

As the release liner, a polyethylene terephthalate (PET) film having a length of 4 cm, a width of 5 cm, and a thickness of 0.5 mm was prepared. The 5 cm side to the opposite 5 cm side of this release liner was subjected to streak carving with TAMIYA CRAFT TOOLS FINEENGRAVING BLADE (streak carving super hard blade, 0.4 mm, manufactured by Tamiya Inc.) to form a concave slit (as shown FIG. 7A) having a depth of 0.2 mm and a width of 0.4 mm. In the formed slit, the threadlike adhesive body having a length of 4 cm prepared as described above was disposed to obtain a release liner-attached adhesive body in Example 5.

### Example 6

A release liner-attached adhesive body in Example 6 was obtained in the same manner as in Example 5, except that the slit was changed to a V-shaped slit (as shown in FIG. 6A) having a depth of 0.4 mm and a width of 0.4 mm.

The V-shaped slit was formed by applying a 5 cm razor blade diagonally to the surface of the release liner from the 5 cm side to the opposite 5 cm side of the release liner and gradually hitting a hammer.

### Example 7

A release liner-attached adhesive body in Example 7 was obtained in the same manner as in Example 5, except that the slit was changed to a V-shaped slit (as shown in FIG. 6A) having a depth of 0.2 mm and a width of 0.4 mm

The V-shaped slit was formed by applying a 5 cm razor blade diagonally to the surface of the release liner from the 5 cm side to the opposite 5 cm side of the release liner and gradually hitting a hammer.

### Example 8

A release liner-attached adhesive body in Example 8 was obtained in the same manner as in Example 5, except that a polyethylene foam base material (manufactured by Nitto Denko Corporation) having a length of 4 cm, a width of 5 cm, and a thickness of 0.5 mm was used as the release liner.

### Example 9

As the release liner, a polyethylene foam base material (manufactured by Nitto Denko Corporation) having a length of 4 cm, a width of 5 cm, and a thickness of 0.5 mm was prepared. From one side to the opposite side of this release liner, a notched slit as shown in FIG. 5A having a depth of 0.2 mm was formed. In the formed slit, the threadlike adhesive body having a length of 4 cm prepared as described above was disposed to obtain a release liner-attached adhesive body in Example 9.

The notched slit was formed by applying a 5 cm razor blade vertically to the surface of the release liner from the 5 cm side to the opposite 5 cm side of the release liner and gradually hitting a hammer.

### Comparative Example 1

A release liner-attached adhesive body in Comparative Example 1 was obtained in the same manner as in Example 1, except that a polyethylene terephthalate (PET) film having a length of 4 cm, a width of 4 cm, and a thickness of 0.5 mm was used as the release liner.

### (Compression Elastic Modulus)

The compression elastic modulus of the release liner was measured by the following compression test using an autograph (small desktop tester EXtest manufactured by Shimadzu Corporation). The results are shown in Table 1.

A release liner (length 4 cm×width 4 cm) used in each of Examples was placed on an acrylic table in a room with a temperature of 23° C., the compression stress was measured while pressing a cylindrical indenter (made of SUS, indenter area: 100 mm²) in a direction perpendicular to the center of the release liner at a compression rate of 0.1 mm/min, and the compression elastic modulus E (MPa) was calculated according to the following equation.

E (MPa)=(σ2−σ1)/(ε2−ε1)

Compression stress σ1: 0.005 (MPa)

Compression stress σ2: 0.01 (MPa)

Compression strain value ε1: compression strain value under compression stress σ1

Compression strain value ε2: compression strain value under compression stress σ2

### (Shape Retention Property of Adhesive Body)

The release liner-attached adhesive body prepared in each of Examples was placed on a first acrylic plate having a length of 4 cm and a width of 4 cm such that the surface of the release liner-attached adhesive body on the side having the adhesive body faces downward, and then a second acrylic plate is placed thereon (first acrylic plate/adhesive body/release liner/second acrylic plate). A load of 2 kg was applied from above for 20 minutes, and it was visually confirmed whether the shape of the adhesive body was retained after unloading according to the following evaluation criteria. Results are shown in Tables 1 and 2.

A: the shape same as the shape before the load is applied is retained.

B: the shape is almost the same as the shape before the load is applied.

C: the adhesive body is crushed and spreads laterally, but the shape of the adhesive body is retained.

D: the adhesive body is crushed and spreads sideways, and the shape of the adhesive body cannot be retained.

TABLE 1

| | ε1 | ε2 | E (MPa) = | Shape retention |
|---|---|---|---|---|
| | σ1: 0.005 | σ2: 0.01 | (σ2 − σ1)/ | property of |
| | (MPa) | (MPa) | (ε2 − ε1) | adhesive body |
| Example 1 | 0.104 | 0.162 | 0.09 | B |
| Example 2 | 0.028 | 0.038 | 0.50 | B (adhesive on |
| | | | | embossed surface) |
| Example 3 | 0.016 | 0.021 | 0.96 | B |
| Example 4 | 0.008 | 0.012 | 1.25 | C |
| Comparative | 0.014 | 0.017 | 1.92 | D |
| Example 1 | | | | |

As shown in Table 1, in the release liner-attached adhesive bodies in Examples 1 to 4 in which the compression elastic modulus of the release liner is 1.5 MPa or less, the crushing of the adhesive body is suppressed or prevented and the shape of the adhesive body is retained even after the load is applied. On the other hand, in the release liner-attached adhesive body in Comparative Example 1 in which the compression elastic modulus of the release liner is more than 1.5 MPa, the adhesive body is crushed and the shape of the adhesive body cannot be retained after the load is applied.

TABLE 2

| | Release liner | | ε1 | ε2 | E (MPa) = | Shape retention |
|---|---|---|---|---|---|---|
| | Type | | σ1: 0.005 | σ2: 0.01 | (σ2 · σ1)/ | property of |
| | (thickness) | Slit shape | (MPa) | (MPa) | (ε2 · ε1) | adhesive body |
| Example 5 | PET | Concave shape, | 0.014 | 0.017 | 1.92 | B |
| | (0.5 mm) | depth 0.2 mm, | | | | |
| | | thickness 0.4 mm | | | | |
| Example 6 | PET | V-shape, | 0.014 | 0.017 | 1.92 | B |
| | (0.5 mm) | depth 0.4 mm, | | | | |
| | | thickness 0.4 mm | | | | |
| Example 7 | PET | V-shape, | 0.014 | 0.017 | 1.92 | C |
| | (0.5 mm) | depth 0.2 mm, | | | | |
| | | thickness 0.4 mm | | | | |
| Example 8 | PE | Concave shape, | 0.104 | 0.162 | 0.09 | A |
| | (0.5 mm) | depth 0.2 mm, | | | | |
| | | thickness 0.4 mm | | | | |
| Example 9 | PE | Notched shape, | 0.104 | 0.162 | 0.09 | B |
| | (0.5 mm) | depth 0.2 mm | | | | |

As shown in Table 2, in the release liner-attached adhesive bodies in Examples 5 to 9 in which a slit is formed in the release liner and the adhesive body is disposed in the slit, the crushing of the adhesive body is suppressed or prevented and the shape of the adhesive body is retained even after the load is applied.

Even in the release liner-attached adhesive bodies in Examples 5 to 7 in which the compression elastic modulus of the release liner is more than 1.5 MPa, the slit formed in the release liner prevents the adhesive body from being deformed and crushed. In Example 7, where the slit is shallower than that of Example 6, the adhesive body is crushed and spreads laterally, but the shape of the adhesive body is retained.

In Example 8 in which the compression elastic modulus of the release liner is 1.5 MPa or less, no deformation of the adhesive body is observed. In addition, in Example 9, the shape is almost the same as the shape before the load is applied.

The release liner-attached adhesive body according to the present invention described above is preferred since the linear adhesive body is protected while crushing and falling are suppressed or prevented. In addition, according to the release liner-attached adhesive body of the present invention, even a linear adhesive body with a large adhesive force can be protected while crushing and falling are suppressed or prevented.

The present invention is not limited to the above embodiment, and may be appropriately modified, improved or the like. Materials, shapes, sizes, numerical values, forms, numbers, arrangement positions, and the like of components in the embodiments described above are set as desired and are not limited as long as the present invention can be achieved.

Although preferred embodiments of the present invention have been described above, the present invention is not limited to the above embodiments, and various modifications and substitutions can be added to the above embodiments without departing from the scope of the present invention.

The present application is based on a Japanese patent application (No. 2020-064046) filed on Mar. 31, 2020, contents of which are incorporated herein by reference.

### REFERENCE SIGNS LIST

10, 20, 30, 40 release liner-attached adhesive body
11, 21, 31, 41 adhesive body
12, 22, 32, 42 release liner
32a, 42a surface of release liner where slit is formed
14 reel
23, 33, 43 slit

1. A release liner-attached adhesive body, comprising:
a linear adhesive body; and
a release liner, wherein
the release liner has a compression elastic modulus of 1.5 MPa or less.

2. The release liner-attached adhesive body according to claim 1, wherein a slit is formed in the release liner, and at least a part of the adhesive body is disposed in the slit.

3. A release liner-attached adhesive body, comprising:
a linear adhesive body; and
a release liner, wherein
a slit is formed in the release liner, and at least a part of the adhesive body is disposed in the slit.

4. The release liner-attached adhesive body according to claim 3, wherein the slit is formed along a longitudinal direction of the release liner.

5. The release liner-attached adhesive body according to claim 3, wherein the adhesive body is threadlike.

6. The release liner-attached adhesive body according to claim 3, wherein the release liner-attached adhesive body is wound in a roll shape.

7. The release liner-attached adhesive body according to claim 2, wherein the slit is formed along a longitudinal direction of the release liner.

8. The release liner-attached adhesive body according to claim 1, wherein the adhesive body is threadlike.

9. The release liner-attached adhesive body according to claim 2, wherein the adhesive body is threadlike.

10. The release liner-attached adhesive body according to claim 7, wherein the adhesive body is threadlike.

11. The release liner-attached adhesive body according to claim 1, wherein the release liner-attached adhesive body is wound in a roll shape.

12. The release liner-attached adhesive body according to claim 2, wherein the release liner-attached adhesive body is wound in a roll shape.

13. The release liner-attached adhesive body according to claim 7, wherein the release liner-attached adhesive body is wound in a roll shape.

14. The release liner-attached adhesive body according to claim 8, wherein the release liner-attached adhesive body is wound in a roll shape.

15. The release liner-attached adhesive body according to claim 9, wherein the release liner-attached adhesive body is wound in a roll shape.

16. The release liner-attached adhesive body according to claim 10, wherein the release liner-attached adhesive body is wound in a roll shape.

17. The release liner-attached adhesive body according to claim 4, wherein the adhesive body is threadlike.

18. The release liner-attached adhesive body according to claim 4, wherein the release liner-attached adhesive body is wound in a roll shape.

19. The release liner-attached adhesive body according to claim 5, wherein the release liner-attached adhesive body is wound in a roll shape.

20. The release liner-attached adhesive body according to claim 17, wherein the release liner-attached adhesive body is wound in a roll shape.
